(19) United States
(12) Patent Application Publication
(10) Pub. No.: US 2024/0047830 A1
(43) Pub. Date: Feb. 8, 2024

(54) ELECTROCHEMICAL APPARATUS AND ELECTRONIC APPARATUS INCLUDING THE ELECTROCHEMICAL APPARATUS

(71) Applicant: Ningde Amperex Technology Limited, Ningde (CN)

(72) Inventor: Jun HE, Ningde (CN)

(73) Assignee: Ningde Amperex Technology Limited, Ningde (CN)

(21) Appl. No.: 18/453,519

(22) Filed: Aug. 22, 2023

(30) Foreign Application Priority Data
Aug. 2, 2022 (CN) 202210922280.6

(51) Int. Cl. H01M 50/489; H01M 10/0525; H01M 50/449; H01M 4/133; H01M 4/587; H01M 50/434; H01M 50/417; H01M 50/426

(52) U.S. Cl. CPC H01M 50/489; H01M 10/0525; H01M 50/449; H01M 4/133; H01M 4/587; H01M 50/434; H01M 50/417; H01M 50/426; H01M 2004/021

(57) ABSTRACT

An electrochemical apparatus, includes an electrode assembly having a positive electrode plate; a negative electrode plate including a negative electrode current collector, a second active material having a second active substance, and a first active material layer having a first active substance located between the negative electrode current collector and the second active material layer; and a separator disposed between the positive electrode plate and the negative electrode plate. Compacted density of the first active material layer is greater than compacted density of the second active material layer. Sphericity of the first active substance is smaller than sphericity of the second active substance. The separator includes a porous substrate layer and a first coating layer disposed on at least one surface of the porous substrate layer facing the second active material layer. 20 N/m≥Adhesion between the separator and the negative electrode plate≥2 N/m.

### CROSS REFERENCE TO RELATED APPLICATIONS

The present application claims priority to Chinese Patent application No. CN 202210922280.6 filed in the China National Intellectual Property Administration on Aug. 2, 2022, the entire content of which is hereby incorporated by reference.

### FIELD

This application relates to the field of electrochemical technologies, and in particular, to an electrochemical apparatus and an electronic apparatus including the electrochemical apparatus.

### BACKGROUND

In recent years, with the continuous development and iteration of consumer electrochemical apparatuses (such as lithium-ion batteries), the market is demanding higher charging speeds for electrochemical apparatuses, and the market share of super-fast-charging electrochemical apparatuses is gradually increasing. However, compared to electrochemical apparatuses with normal charging speeds, super-fast-charging electrochemical apparatuses have lower energy density and poorer high-temperature stability.

To overcome the issues above, persons skilled in the art typically replace the conventional separators in electrochemical apparatuses with high-adhesion separators to improve the energy density and high-temperature stability of the electrochemical apparatuses. However, high-adhesion separators have poorer wettability compared to conventional separators, and gaps between these separators and the positive or negative electrode plates are small, easily leading to a reduction in the transport speed of electrolytes. Especially under low and medium temperatures, the kinetic performance of the electrochemical apparatus system is insufficient, and the electrolytes in the electrochemical apparatuses are insufficient in the charge and discharge cycles, affecting the low- and medium-temperature cycling performance of the electrochemical apparatuses.

In view of this, it is an urgent technical challenge for persons skilled in the art to improve the cycling performance and rate performance of electrochemical apparatuses while ensuring high energy density and good high-temperature stability of the electrochemical apparatuses, that is, to develop an electrochemical apparatus with good and overall performance.

### SUMMARY

This application is intended to provide an electrochemical apparatus and an electronic apparatus including such electrochemical apparatus, so as to improve the overall performance of electrochemical apparatuses.

It should be noted that in the summary of this application, a lithium-ion battery is used as an example of an electrochemical apparatus to explain this application. However, the electrochemical apparatus of this application is not limited to the lithium-ion battery. This application is also applicable to common secondary batteries such as sodium-ion batteries and lithium-sulfur batteries. Specific technical solutions of this application are as follows:

A first aspect of this application provides an electrochemical apparatus including an electrode assembly. The electrode assembly includes a positive electrode plate, a negative electrode plate, and a separator disposed between the positive electrode plate and the negative electrode plate. The negative electrode plate includes a negative electrode current collector and a first active material layer and a second active material layer disposed on at least one surface of the negative electrode current collector, the first active material layer being located between the negative electrode current collector and the second active material layer. The first active material layer includes a first active substance, and the second active material layer includes a second active substance, where compacted density of the first active material layer is greater than compacted density of the second active material layer, and sphericity of the first active substance is smaller than sphericity of the second active substance. The separator includes a porous substrate layer and a first coating layer, where the first coating layer is at least disposed on one surface of the porous substrate layer facing the second active material layer, and adhesion between the separator and the negative electrode plate is greater than or equal to 2 N/m and less than or equal to 20 N/m.

In an embodiment of this application, based on total mass of the first active material layer and the second active material layer, a mass percentage of the first active material layer is 10% to 90%.

Preferably, based on total mass of the first active material layer and the second active material layer, a mass percentage of the first active material layer is 20% to 80%.

In an embodiment of this application, the compacted density of the first active material layer is D1, where 1.7 g/cm³<D1≤1.9 g/cm³; the compacted density of the second active material layer is D2, where 1.5 g/cm³≤D2≤1.7 g/cm³; the sphericity of the first active substance is S1, where 0.7≤S1≤0.8; and the sphericity of the second active substance is S2, where 0.8<S2≤0.9.

In an embodiment of this application, the first active substance and the second active substance are each independently selected from at least one selected from the group consisting of a carbon-based material, a silicon-based material, and a tin-based material, where the carbon-based material includes at least one selected from the group consisting of natural graphite, artificial graphite, soft carbon, hard carbon, and mesocarbon microbeads.

In an embodiment of this application, both the first active substance and the second active substance are carbon-based materials; the first active substance has a peak intensity ratio of peak d to peak g in the Raman test is Id₁/Ig₁, where 0<Id₁/Ig₁<0.2; and the second active substance has a peak intensity ratio of peak d to peak g in the Raman test is Id₂/Ig₂, where 0.2<Id₂/Ig₂≤1; where peak d has a wavenumber range of 1270 cm⁻¹ to 1330 cm⁻¹ in the Raman spectrum, and peak g has a wavenumber range of 1550 cm⁻¹ to 1610 cm⁻¹ in the Raman spectrum.

In an embodiment of this application, a second coating layer is further disposed between the porous substrate layer and the first coating layer, where the second coating layer includes heat-resistant particles, and the heat-resistant particles include at least one selected from the group consisting of alumina, boehmite, barium sulfate, titanium dioxide, and magnesium hydroxide.

In an embodiment of this application, a ratio of area of the first coating layer to area of the porous substrate layer is 0.10 to 0.85, meaning that the projected area of the first coating layer in a thickness direction of the negative electrode plate covers 10% to 85% of the area of the porous substrate layer. Preferably, a ratio of area of the first coating layer to area of the porous substrate layer is 0.30 to 0.70.

In an embodiment of this application, the first coating layer includes polymer particles, where the polymer particles include at least one selected from the group consisting of polymers polymerized from at least one selected from the group consisting of the following monomers: vinylidene chloride, vinylidene fluoride, hexafluoropropylene, styrene, butadiene, acrylonitrile, acrylic acid, methyl acrylate, and butyl acrylate. Preferably, the polymer particles include at least one selected from the group consisting of polyvinylidene fluoride, polyvinylidene chloride, styrene-butadiene copolymer, polyacrylonitrile, butadiene-acrylonitrile copolymer, polyacrylic acid, methyl acrylate-styrene copolymer, and butyl acrylate-styrene copolymer.

In an embodiment of this application, a median particle size D50 of the polymer particles is 0.2 μm to 2 μm, and preferably, the median particle size D50 of the polymer particles is 0.3 μm to 1 μm.

In an embodiment of this application, a swelling degree of the polymer particles is 20% to 100%.

In an embodiment of this application, the polymer particles are core-shell structured microspheres, the polymer particle includes a shell and a core, where the shell includes at least one selecting from polymers polymerized from at least one selected from the group consisting of the following monomers: polyvinyl chloride, polyvinyl fluoride, hexafluoropropylene, polystyrene, polybutadiene, acrylonitrile, acrylic acid, methyl acrylate, and butyl acrylate; and the core includes at least one selected from the group consisting of acrylate and acrylate polymer. Preferably, the shell includes at least one selecting from polyvinylidene fluoride, polyvinylidene chloride, styrene-butadiene copolymer, polyacrylonitrile, butadiene-acrylonitrile copolymer, polyacrylic acid, methyl acrylate-styrene copolymer, and butyl acrylate-styrene copolymer. Preferably, the core includes at least one selecting from methyl acrylate and butyl acrylate.

A second aspect of this application provides an electronic apparatus including the electrochemical apparatus according to the first aspect of this application.

This application has the following beneficial technical effects:

This application provides an electrochemical apparatus and an electronic apparatus including such electrochemical apparatus. The electrochemical apparatus includes an electrode assembly, where the electrode assembly includes a positive electrode plate, a negative electrode plate, and a separator disposed between the positive electrode plate and the negative electrode plate; the negative electrode plate includes a negative electrode current collector and a first active material layer and a second active material layer disposed on at least one surface of the negative electrode current collector, the first active material layer being located between the negative electrode current collector and the second active material layer; the first active material layer includes a first active substance, and the second active material layer includes a second active substance, where compacted density of the first active material layer is greater than compacted density of the second active material layer, and sphericity of the first active substance is smaller than sphericity of the second active substance; and the separator includes a porous substrate layer and a first coating layer, where the first coating layer is at least disposed on one surface of the porous substrate layer facing the second active material layer, and adhesion between the separator and the negative electrode plate is greater than or equal to 2 N/m and less than or equal to 20 N/m. In this application, the separator exhibits strong adhesion, and the negative electrode plate is provided with a second active material layer with a lower compacted density and a second active substance with a larger sphericity. Through use of the separator and negative electrode plate of this application in combination, a synergistic effect is achieved between the separator and the negative electrode plate, improving the overall performance of the electrochemical apparatus. For example, the electrochemical apparatus exhibits high energy density and good high-temperature stability, good cycling performance, and good rate performance.

Certainly, implementation of any of the products or methods of the present application does not necessarily need to achieve all of the advantages described above simultaneously.

### BRIEF DESCRIPTION OF DRAWINGS

To describe the technical solutions of the embodiments of this application or the prior art more clearly, the following briefly describes the accompanying drawings required for describing the embodiments or the prior art. Apparently, the accompanying drawings in the following descriptions show merely some embodiments of this application, and persons of ordinary skill in the art may still derive other embodiments from the accompanying drawings.

FIG. 1 is a schematic diagram showing a sectional structure of a separator according to an embodiment of this application;

FIG. 2 is a schematic structural diagram (top view) of a first coating layer and a porous substrate layer in FIG. 1;

FIG. 3 is a schematic diagram showing a sectional structure of a separator according to an embodiment of this application; and

FIG. 4 shows Raman spectra of a first active substance and a second active substance of Example 1-2.

### DETAILED DESCRIPTION

The following clearly describes the technical solutions in the embodiments of this application with reference to the accompanying drawings in the embodiments of this application. Apparently, the described embodiments are merely some but not all embodiments of this application. All other embodiments obtained by persons of ordinary skill in the art based on the embodiments of this application shall fall within the protection scope of this application.

It should be noted that in the specific embodiments of this application, a lithium-ion battery is used as an example of an electrochemical apparatus to explain this application. However, the electrochemical apparatus in this application is not limited to the lithium-ion battery, and may alternatively be a sodium-ion battery, a lithium-sulfur battery, a sodium-sulfur battery, or other common secondary batteries. Specific technical solutions of this application are as follows:

A first aspect of this application provides an electrochemical apparatus including an electrode assembly. The electrode assembly includes a positive electrode plate, a negative electrode plate, and a separator disposed between the positive electrode plate and the negative electrode plate. The negative electrode plate includes a negative electrode current collector, a first active material layer and a second active material layer disposed on at least one surface of the negative electrode current collector, the first active material layer being located between the negative electrode current collector and the second active material layer. The first active material layer includes a first active substance, and the second active material layer includes a second active substance, where compacted density of the first active material layer is greater than compacted density of the second active material layer, and sphericity of the first active substance is smaller than sphericity of the second active substance. The separator includes a porous substrate layer and a first coating layer, where the first coating layer is at least disposed on one surface of the porous substrate layer facing the second active material layer, and adhesion between the separator and the negative electrode plate is greater than or equal to 2 N/m and less than or equal to 20 N/m.

In this application, “a first active material layer and a second active material layer disposed on at least one surface of the negative electrode current collector” means that the first active material layer and the second active material layer may both be disposed on one surface of the positive electrode current collector in its thickness direction, or may be disposed on two surfaces of the positive electrode current collector in its thickness direction. “The first coating layer is at least disposed on one surface of the porous substrate layer facing the second active material layer” means that the first coating layer may be disposed on one surface of the porous substrate layer facing the second active material layer in a thickness direction of the porous substrate layer, that is, the first coating layer is adjacent to the second active material layer; or that the first coating layer may be disposed on two surfaces of the porous substrate layer in the thickness direction of the porous substrate layer.

In this application, “compacted density” refers to the density of the first active substance and/or the second active substance in the negative electrode plate after cold pressing. In this application, the compacted density of the negative electrode active material layer can be regulated by adjusting the roller gap size and preset pressure value of the cold press machine. This is not particularly limited in this application, as long as the compacted density of the negative electrode active material layer is controlled within the range defined in this application. “Sphericity” is a parameter that characterizes the morphology of particles (particles of the first active substance and particles of the second active substance). In this application, a particle that resembles a sphere more has a sphericity value closer to 1. The sphericity of the first active substance and the second active substance can be adjusted by controlling the granulation processes of the first active substance and second active substance. This is not particularly limited in this application, and the granulation process parameters known to persons skilled in the art can be used, as long as the sphericity is controlled within the range defined in this application.

In this application, the adhesion force between the separator and the negative electrode plate is set to be greater than or equal to 2 N/m and less than or equal to 20 N/m, which provides strong adhesion between them. This can enhance the interface adhesion between the separator and the negative electrode plate, effectively reduce the occurrence of side reactions during the cycling process of the electrochemical apparatus, reduce electrolyte consumption, and suppress gas generation in the electrolyte at high temperatures, thereby improving the high-temperature storage performance of the electrochemical apparatus. If the adhesion force between the separator and the negative electrode plate is excessively low, the desired effects cannot be achieved. Therefore, the lower limit of the adhesion force between the separator and the negative electrode plate is set to be 2 N/m. Theoretically, the upper limit of the adhesion force between the separator and the negative electrode plate is not particularly limited, but considering factors such as cost and assembly, the upper limit of the adhesion force between the separator and the negative electrode plate is set to be 20 N/m. Due to the small particles of the first coating layer in the highly adhesive separator, the space between the negative electrode plate and the separator held up by the first coating layer is relatively small, which means that the channel for electrolyte transport is narrow, resulting in slow electrolyte transport. Both the first active material layer and the second active material layer are disposed in the negative electrode plate, making the negative electrode plate a double-layer active substance structure. The compacted density of the first active material layer is greater than that of the second active material layer, resulting in a higher porosity of the second active material layer compared to the first active material layer. The sphericity of the first active substance is lower than that of the second active substance, resulting in lower tortuosity of the pores in the second active material layer. The second active material layer on the surface layer has a higher porosity and lower tortuosity compared to the underlying first active material layer. In this way, a wider channel for electrolyte transport is constructed between the negative electrode plate and the highly adhesive separator, which can effectively enhance the speed of electrolyte transport to the middle of the electrochemical apparatus during the cycling process, and alleviate the adverse effect on electrolyte transport caused by the small thickness of the highly adhesive separator, thereby improving the cycling performance during high-rate fast charging under medium and low temperatures. Furthermore, the lower compacted density of the second active material layer means that compared to the first active material layer, the second active material layer has a higher internal porosity when subjected to the cold pressing pressure on the negative electrode plate, facilitating lithium ion transport and achieving good kinetic performance for the second active substance. The higher sphericity of the second active substance reduces the tortuosity of the pores in the second active material layer, facilitating lithium ion transport and achieving good kinetic performance for the second active substance. The good kinetic performance of the second active substance further expands the rate window of the electrochemical apparatus, improving the rate performance of the electrochemical apparatus. In this application, the highly adhesive separator is used with the negative electrode plate having dual active material layers, so that a synergistic effect is achieved between the separator and the negative electrode plate, improving the cycling performance, rate performance, and high-temperature stability of the electrochemical apparatus, thereby enhancing the overall performance of the electrochemical apparatus. In this application, “high temperature” refers to a temperature range of 45° C. to 85° C., and “medium and low temperature” refers to a temperature range of 25° C. to 0° C.

In one embodiment of this application, the porous substrate layer includes a porous substrate. The material of the porous substrate is not particularly limited in this application and may be a material known in the art, provided that the objectives of this application can be achieved. For example, the material of the porous substrate includes polypropylene, polyethylene, polyethylene terephthalate, cellulose, or polyimide. The porosity of the porous substrate is not particularly limited in this application and may be a porosity known in the art, provided that the objectives of this application can be achieved. For example, the porosity of the porous substrate is from 30% to 45%. The thickness of the porous substrate layer is not particularly limited in this application and may be a thickness known in the art, provided that the objectives of this application can be achieved. For example, the thickness of the porous substrate layer is from 4 μm to 12 μm.

In an embodiment of this application, based on total mass of the first active material layer and the second active material layer, a mass percentage W1 of the first active material layer is from 10% to 90%. For example, the mass percentage of the first active material layer is 10%, 20%, 30%, 40%, 50%, 60%, 70%, 80%, 90%, or any value in a range between any two of the above values. If the mass percentage of the first active material layer is too low (for example, below 10%), the mass percentage of the second active material layer will be too high, so that the second active substance accounts for an over-high proportion in the total of the first active substance and second active substance, leading to a decrease in the overall energy density of the electrochemical apparatus. If the mass percentage of the first active material layer is too high (for example, above 90%), the mass percentage of the second active material layer will be too low, the construction of the electrolyte transport channel between the negative electrode plate and the separator is affected and the speed of electrolyte transport to the middle of the electrochemical apparatus during the cycling process is also affected, thereby deteriorating the cycling performance of the electrochemical apparatus. This also affects the utilization of high kinetic performance of the second active substance, thus affecting the rate performance of the electrochemical apparatus. With the mass percentage of the first active material layer being controlled within the above range, a good ratio is achieved between the first active material layer and the second active material layer in the negative electrode plate, implementing cooperation between the first active material layer and the second active material layer, which is more conducive to improving the overall performance of the electrochemical apparatus.

Preferably, based on total mass of the first active material layer and the second active material layer, a mass percentage of the first active material layer is 20% to 80%. For example, the mass percentage of the first active material layer is 20%, 30%, 40%, 50%, 60%, 70%, 80%, or any value in a range between any two of the above values. With the mass percentage of the first active material layer being controlled within the above range, the energy density and cycling performance of the electrochemical apparatus can be better balanced.

In an embodiment of this application, the compacted density of the first active material layer is D1, where 1.7 g/cm³<D1≤1.9 g/cm³; and the compacted density of the second active material layer is D2, where 1.5 g/cm³≤D2≤1.7 g/cm³. For example, the compacted density D1 of the first active material layer is 1.71 g/cm³, 1.75 g/cm³, 1.80 g/cm³, 1.85 g/cm³, 1.9 g/cm³, or any value in a range between any two of the above values. The compacted density D2 of the second active material layer is 1.5 g/cm³, 1.55 g/cm³, 1.6 g/cm³, 1.65 g/cm³, 1.7 g/cm³, or any value in a range between any two of the above values. With the compacted density D1 of the first active material layer and the compacted density D2 of the second active material layer being controlled within the above ranges, the second active material layer has a higher porosity than the first active material layer without affecting the cycling performance, energy density, or rate performance of the electrochemical apparatus. The sphericity of the first active substance is S1, where 0.7≤S1≤0.8; and the sphericity of the second active substance is S2, where 0.8≤S2≤0.9. For example, the sphericity S1 of the first active substance is 0.7, 0.72, 0.74, 0.76, 0.78, 0.8, or any value in a range between any two of the above values. The sphericity S2 of the second active substance is 0.8, 0.82, 0.84, 0.86, 0.88, 0.9, or any value in a range between any two of the above values. With the sphericity S1 of the first active substance and the sphericity S2 of the second active substance being controlled within the above ranges, the second active material has a lower pore tortuosity than the first active material layer. With D1, D2, S1, and S2 being controlled within the above ranges, the second active material layer has a higher porosity and lower tortuosity compared to the first active material layer. In this way, a wider channel for electrolyte transport is constructed between the negative electrode plate and the highly adhesive separator, which can effectively enhance the speed of electrolyte transport to the middle of the electrochemical apparatus during the cycling process, and alleviate the adverse effect on electrolyte transport caused by the small thickness of the highly adhesive separator, thereby improving the cycling performance during high-rate fast charging under medium and low temperatures. Thus, a synergistic effect is achieved between the negative electrode plate and the separator, improving the energy density, kinetic performance, cycling performance, rate performance, and high-temperature stability of the electrochemical apparatus, thereby enhancing the overall performance of the electrochemical apparatus.

In an embodiment of this application, the first active substance and the second active substance are each independently selected from at least one selected from the group consisting of a carbon-based material, a silicon-based material, and a tin-based material, where the carbon-based material includes at least one selected from the group consisting of natural graphite, artificial graphite, soft carbon, hard carbon, and mesocarbon microbeads. The natural graphite includes but is not limited to natural flake graphite. The use of the above types of first and second active substances is more conducive to improving the energy density and rate performance of the electrochemical apparatus.

The silicon-based material and tin-based material are not particularly limited in this application, provided that the objectives of this application can be achieved. For example, the silicon-based material includes at least one selected from the group consisting of SiOx (0<x≤2), SiC, and silicon nanowire composite material. The tin-based material includes at least one selected from the group consisting of tin oxide and tin-based composite oxide.

In an embodiment of this application, both the first active substance and the second active substance are carbon-based materials; and the first active substance has a peak intensity ratio of peak d to peak g in the Raman test is Id₁/Ig₁, where 1<Id₁/Ig₁<0.2. For example, Id₁/Ig₁ is 0.01, 0.05, 0.1, 0.15, 0.19, 0.199, or any value in a range between any two of the above values. The second active substance has a peak intensity ratio of peak d to peak g in the Raman test is Id₂/Ig₂, where 0.2<Id₂/Ig₂≤1. For example, Id₂/Ig₂ is 0.21, 0.3, 0.4, 0.5, 0.6, 0.7, 0.8, 0.9, 1, or any value in a range between any two of the above values. With Id₁/Ig₁ and Id₂/Ig₂ being controlled within the above ranges, the coating degree of the second active substance is higher than that of the first active substance, and the activity on the surface of the second active substance is higher than that of the first active substance, facilitating lithium insertion reaction on the surface of the second active substance and improving the kinetic performance of the second active substance. As a result, the second active substance has a higher rate capability compared to the first active substance, thereby improving the rate performance of the electrochemical apparatus. In this application, peak d is a peak with a wavenumber range of 1280 cm⁻¹ to 1330 cm⁻¹ in the Raman spectrum of the first active substance or second active substance, and peak g is a peak with a wavenumber range of 1550 cm⁻¹ to 1610 cm⁻¹ in the Raman spectrum of the first active substance or second active substance. The “coating degree” refers to a mass of amorphous carbon coating the surface of the first active substance or the second active substance. “The coating degree of the second active substance is higher than that of the first active substance” means that the mass of amorphous carbon coating the surface of the second active substance is greater than that coating the surface of the first active substance.

In this application, the values of Id₁/Ig₁ and Id₂/Ig₂ can be controlled by selecting different types of negative electrode active materials. This is not particularly limited in this application, provided that the values of Id₁/Ig₁ and Id₂/Ig₂ are controlled within the ranges of this application.

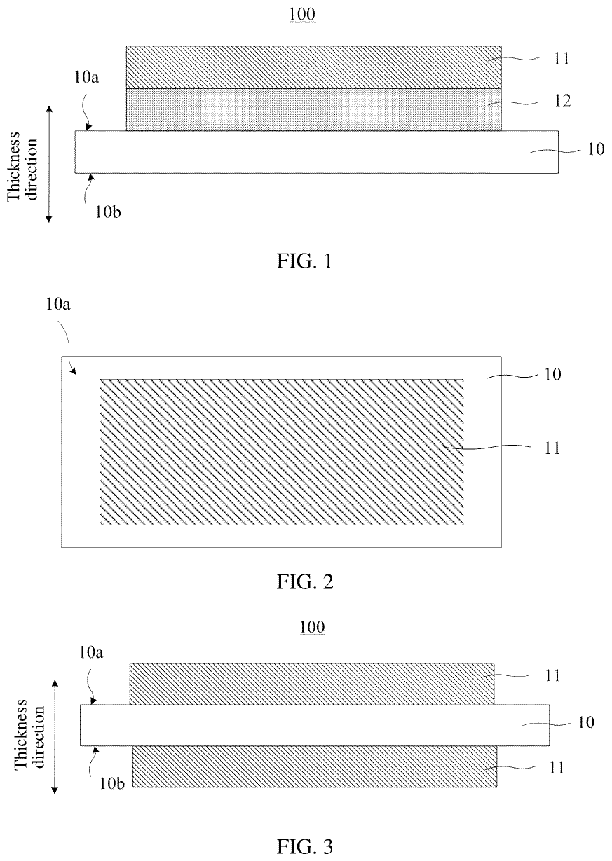

In one embodiment of this application, a second coating layer is further disposed between the porous substrate layer and the first coating layer. For example, as shown in FIG. 1, the separator 100 includes a porous substrate layer 10, a first coating layer 11, and a second coating layer 12. The first coating layer 11 is disposed on a first surface 10a of the porous substrate layer 10 facing the second active material layer (not shown in the figure) in a thickness direction of the porous substrate layer 10, and the second coating layer 12 is disposed between the porous substrate layer 10 and the first coating layer 11. Certainly, in some embodiments of this application, the first coating layer 11 and the second coating layer 12 may both be disposed on a second surface 10b of the porous substrate layer 10 facing away from the second active material layer in the thickness direction of the porous substrate layer 10. The second coating layer includes heat-resistant particles, and the heat-resistant particles include at least one selected from the group consisting of alumina, boehmite, barium sulfate, titanium dioxide, and magnesium hydroxide. When the second coating layer is disposed in the separator and includes the above materials, the separator is less likely to shrink at high temperatures, preventing short circuits between the positive and negative electrodes. It also prevents self-discharge and suppresses side reactions of the positive and negative electrodes during the cycling process of the electrochemical apparatus, thus improving the cycling performance of the electrochemical apparatus and effectively enhancing the safety performance of the electrochemical apparatus.

In an embodiment of this application, the second coating layer has a thickness of 1.5 μm to 3 μm. With the thickness of the second coating layer being controlled within the above range, the thickness of the separator in this application is controlled to be 7.5 μm to 9 μm, which is thinner compared to the non-highly-adhesive separator with an initial thickness of 15 μm to 20 μm in the prior art. In this way, the energy density of the electrochemical apparatus can be improved by the reduction of its overall volume. Moreover, the adhesion force of the separator meets the requirements of this application, allowing the separator to work in synergy with the negative electrode plate, resulting in an improved overall performance of the electrochemical apparatus.

The ratio of the area of the second coating layer to the area of the porous substrate layer is not particularly limited in this application, provided that the objectives of this application can be achieved. For example, the ratio of the area of the second coating layer to the area of the porous substrate layer is 1, which means that the second coating layer is applied on one or both surfaces of the porous substrate layer.

In an embodiment of this application, as shown in FIG. 2, a ratio of area of the first coating layer 11 to area of the porous substrate layer 10 is from 0.10 to 0.85, which means that the projected area of the first coating layer 11 on the porous substrate layer 10 in a thickness direction of the negative electrode plate (not shown in the figure) covers 10% to 85% of the area of the porous substrate layer 10. For example, the ratio of the area of the first coating layer to the area of the porous substrate layer is 0.10, 0.20, 0.30, 0.40, 0.50, 0.60, 0.70, 0.80, 0.85, or any value in a range between any two of the above values. If the ratio of the area of the first coating layer to the area of the porous substrate layer is too small (for example, less than 0.10), the adhesion force between the separator and the negative electrode plate is affected, thereby affecting the overall performance of the electrochemical apparatus. If the ratio of the area of the first coating layer to the area of the porous substrate layer is too large (for example, greater than 0.85), the overall porosity of the separator is reduced and the tortuosity of the pores in the separator is increased, affecting the rate performance of the electrochemical apparatus. With the ratio of the area of the first coating layer to the area of the porous substrate layer being controlled within the above range, it is more conducive to improving the overall performance of the electrochemical apparatus.

Preferably, a ratio of area of the first coating layer to area of the porous substrate layer is from 0.30 to 0.70. For example, the ratio of the area of the first coating layer to the area of the porous substrate layer is 0.30, 0.40, 0.50, 0.60, 0.70, or any value in a range between any two of the above values. With the ratio of the area of the first coating layer to the area of the porous substrate layer being controlled within the above preferred range, the electrochemical apparatus exhibits better overall performance.

In one embodiment of this application, for example, as shown in FIG. 3, the separator 100 includes a first coating layer 11 and a porous substrate layer 10. The first coating layer 11 is adjacent to the porous substrate layer 10. The first coating layer 11 is disposed on a first surface 10a of the porous substrate layer 10 facing the second active material layer (not shown in the figure) in a thickness direction of the porous substrate layer 10, and the first coating layer 11 may also be disposed on a second surface 10b of the porous substrate layer 10 facing away from the second active material layer in the thickness direction of the porous substrate layer 10. Certainly, in some embodiments of this application, the first coating layer 11 is disposed on only the first surface 10a of the porous substrate layer 10 facing the second active material layer in the thickness direction of the porous substrate layer 10, and the first coating layer 11 is not disposed on the second surface 10b.

In an embodiment of this application, the first coating layer includes polymer particles, where the polymer particles include at least one selected from the group consisting of polymers polymerized from at least one selected from the group consisting of the following monomers: vinylidene chloride, vinylidene fluoride, hexafluoropropylene, styrene, butadiene, acrylonitrile, acrylic acid, methyl acrylate, and butyl acrylate. The use of the above types of polymer particles allows the adhesion force between the separator and the negative electrode plate to be greater than or equal to 2 N/m and less than or equal to 20 N/m. Thus, the highly adhesive separator is used with the negative electrode plate of this application, and a synergistic effect is achieved between the negative electrode plate and the separator, improving the energy density, kinetic performance, cycling performance, rate performance, and high-temperature stability of the electrochemical apparatus, thereby enhancing the overall performance of the electrochemical apparatus.

Preferably, the polymer particles include at least one selected from the group consisting of polyvinylidene fluoride, polyvinylidene chloride, styrene-butadiene copolymer, polyacrylonitrile, butadiene-acrylonitrile copolymer, polyacrylic acid, methyl acrylate-styrene copolymer, and butyl acrylate-styrene copolymer. The use of the above types of polymer particles is conducive to obtaining of a separator with higher adhesion force, further making it favorable for the separator to work in synergy with the negative electrode plate of this application to achieve a synergistic effect. This can further improve the energy density, kinetic performance, cycling performance, rate performance, and high-temperature stability of the electrochemical apparatus, implementing better overall performance for the electrochemical apparatus.

The weight-average molecular weight of the polymer particles is not particularly limited in this application, provided that the objectives of this application can be achieved.

In an embodiment of this application, a median particle size D50 of the polymer particles is from 0.2 μm to 2 μm. For example, D50 is 0.2 μm, 0.4 μm, 0.6 μm, 0.8 μm, 1 μm, 1.2 μm, 1.4 μm, 1.6 μm, 1.8 μm, 2 μm, or any value in a range between any two of the above values. If D50 of the polymer particles is too small (for example, less than 0.2 μm), the polymer particles are prone to agglomeration, resulting in unstable first coating layer slurry. After the first coating layer slurry is applied on the porous substrate layer, polymer particles are unevenly distributed, and the large particles formed by agglomeration of polymer particles will block the pores at the positions of the large particles and affect the transport of electrolyte, thereby affecting the overall performance of the electrochemical apparatus. If D50 of the polymer particles is too large (for example, greater than 2 μm), the first coating layer will be too thick, increasing the overall volume of the electrochemical apparatus and affecting its energy density. With D50 of the polymer particles being controlled within the above range, the overall performance of the electrochemical apparatus can be improved.

Preferably, a median particle size D50 of the polymer particles is 0.3 μm to 1 μm. For example, D50 is 0.3 μm, 0.4 μm, 0.6 μm, 0.8 μm, 1 μm, or any value in a range between any two of the above values. With D50 of the polymer particles being controlled within the above range, the electrochemical apparatus exhibits better overall performance.

In this application, D50 is a corresponding particle size where the cumulative particle size distribution of polymer particles reaches 50%.

In an embodiment of this application, a swelling degree of the polymer particles is from 20% to 100%. For example, the swelling degree is 20%, 30%, 40%, 50%, 60%, 70%, 80%, 90%, 100%, or any value in a range between any two of the above values. When the swelling degree of the polymer particles is controlled within the above range, it indicates that the swelling degree of the polymer particles is small, and the electrochemical apparatus is less likely to swell in the charge and discharge cycles, which is more conducive to improving the overall performance of the electrochemical apparatus.

In an embodiment of this application, the first coating layer has a thickness of 0.7 μm to 3 μm. With the thickness of the first coating layer being controlled within the above range, the thickness of the separator in this application is controlled to be 7.5 μm to 9 μm, which is thinner compared to the non-highly-adhesive separator with an initial thickness of 15 μm to 20 μm in the prior art. In this way, the energy density of the electrochemical apparatus can be improved by the reduction of its overall volume. Moreover, the adhesion force of the separator meets the requirements of this application, which allows the separator to work in synergy with the negative electrode plate, resulting in improved overall performance of the electrochemical apparatus.

In an embodiment of this application, the polymer particles are core-shell structured microspheres, the polymer particle including a shell and a core, where the shell includes at least one selected from the group consisting of polymers polymerized from at least one selected from the group consisting of the following monomers: polyvinyl chloride, polyvinyl fluoride, hexafluoropropylene, polystyrene, polybutadiene, acrylonitrile, acrylic acid, methyl acrylate, and butyl acrylate; and the core includes at least one selected from the group consisting of acrylate and acrylate polymer. The use of the above types of polymer particles including a shell and a core allows the adhesion force between the separator and the negative electrode plate to be greater than or equal to 2 N/m and less than or equal to 20 N/m. Thus, the highly adhesive separator is used with the negative electrode plate of this application, and a synergistic effect is achieved between the negative electrode plate and the separator, improving the energy density, kinetic performance, cycling performance, rate performance, and high-temperature stability of the electrochemical apparatus, thereby enhancing the overall performance of the electrochemical apparatus.

Preferably, the shell includes at least one selected from the group consisting of polyvinylidene fluoride, polyvinylidene chloride, styrene-butadiene copolymer, polyacrylonitrile, butadiene-acrylonitrile copolymer, polyacrylic acid, methyl acrylate-styrene copolymer, and butyl acrylate-styrene copolymer. Preferably, the core includes at least one selected from the group consisting of methyl acrylate and butyl acrylate. The use of the above types of polymer particles including a shell and a core is conducive to obtaining of a separator with higher adhesion, further helping the separator to work in synergy with the negative electrode plate of this application to achieve a synergistic effect. This can further improve the energy density, kinetic performance, cycling performance, rate performance, and high-temperature stability of the electrochemical apparatus, implementing better overall performance for the electrochemical apparatus.

In an embodiment of this application, the first coating layer includes polymer particles, a first auxiliary binder, a dispersant, and a solvent. The types of the first auxiliary binder, dispersant, and first solvent are not particularly limited in this application, provided that the objectives of this application can be achieved. For example, the first auxiliary binder includes acrylic acid, the dispersant includes benzyl ether, and the first solvent includes deionized water. The mass ratio of the polymer particles, first auxiliary binder, dispersant, and first solvent in the first coating layer is not particularly limited in this application, provided that the objectives of this application can be achieved. For example, the mass ratio of the polymer particles, first auxiliary binder, dispersant, and first solvent in the first coating layer is (4-6):(0.2-1.0):(0.2-1.0):(92-96).

In an embodiment of this application, the second coating layer further includes a second auxiliary binder and a second solvent. The types of the second auxiliary binder and second solvent are not particularly limited in this application, provided that the objectives of this application can be achieved. For example, the second auxiliary binder includes butadiene-styrene polymer, and the second solvent includes deionized water. The mass ratio of the heat-resistant particles, second auxiliary binder, and second solvent in the second coating layer is not particularly limited in this application, provided that the objectives of this application can be achieved. For example, the mass ratio of the heat-resistant particles, second auxiliary binder, and second solvent in the second coating layer is (30-40):(8-12):(50-60).

The type of the negative electrode current collector is not particularly limited in this application, provided that the objectives of this application can be achieved. For example, the negative electrode current collector may include copper foil, copper alloy foil, nickel foil, titanium foil, foamed nickel, foamed copper, or the like. The thickness of the negative electrode current collector is not particularly limited in this application, provided that the objectives of this application can be achieved. For example, the thickness of the negative electrode current collector is from 6 μm to 10 μm.

In an embodiment of this application, the first active material layer and the second active material layer each independently include at least one selected from the group consisting of a conductive agent, a stabilizer, and a binder. The types of the conductive agents, stabilizers, and binders in the first active material layer and second active material layer are not particularly limited in this application, provided that the objectives of this application can be achieved.

The mass ratio of the first active substance, conductive agent, stabilizer, and binder in the first active material layer is not particularly limited in this application, provided that the objectives of this application can be achieved. For example, the mass ratio of the first active substance, conductive agent, stabilizer, and binder in the first active material layer is (97-98):(0.5-1.5):(0.5-1.5):(1.0-1.9).

The mass ratio of the second active substance, conductive agent, stabilizer, and binder in the second active material layer is not particularly limited in this application, provided that the objectives of this application can be achieved. For example, the mass ratio of the second active substance, conductive agent, stabilizer, and binder in the second active material layer is (97.5-97.9):(0.5-1.2):(0.4-0.8):(1.0-2.0).

The positive electrode plate of this application includes a positive electrode current collector and a positive electrode active material layer disposed on at least one surface of the positive electrode current collector. “The positive electrode active material layer disposed on at least one surface of the positive electrode current collector” means that the positive electrode active material layer may be disposed on one surface (first surface) of the positive electrode current collector in its thickness direction, or may be disposed on two surfaces (first surface and second surface) of the positive electrode current collector in its thickness direction. It should be noted that the “surface” herein may be an entire region or a partial region of the positive electrode current collector. This is not particularly limited in this application, provided that the objectives of this application can be achieved. The positive electrode current collector is not particularly limited in this application, provided that the objectives of this application can be achieved. For example, the positive electrode current collector may include aluminum foil, aluminum alloy foil, or the like. The positive electrode active material layer includes a positive electrode active substance. The type of the positive electrode active substance is not particularly limited in this application, provided that the objectives of this application can be achieved. For example, the positive electrode active substance may include at least one selected from the group consisting of nickel cobalt lithium manganate (such as the common NCM811, NCM622, NCM523, and NCM111), lithium nickel cobalt aluminate, lithium iron phosphate, lithium-rich manganese-based materials, lithium cobalt oxide (LiCoO₂), lithium manganate, lithium iron manganese phosphate, or lithium titanate. In this application, the positive electrode active substance may further include a non-metal element, for example, fluorine, phosphorus, boron, chlorine, silicon, or sulfur. These elements can further improve stability of the positive electrode active substance. Optionally, the positive electrode active material layer further includes a conductive agent and a binder. The types of the conductive agent and binder in the positive electrode active material layer are not particularly limited in this application, provided that the objectives of this application can be achieved. The mass ratio of the positive electrode active substance, conductive agent, and binder in the positive electrode active material layer is not particularly limited in this application, provided that the objectives of this application can be achieved. In this application, thicknesses of the positive electrode current collector and the positive electrode active material layer are not particularly limited, provided that the objectives of this application can be achieved. For example, the thickness of the positive electrode current collector is from 5 μm to 20 μm, or 6 μm to 18 μm. The thickness of the positive electrode active material layer is from 30 μm to 120 μm.

The electrochemical apparatus of this application further includes an electrolyte, a packaging bag, and the like. The electrolyte and packaging bag are not particularly limited in this application, and may be any electrolyte and packaging bag known in the art, provided that the objectives of this application can be achieved.

The electrochemical apparatus of this application is not particularly limited and may include any apparatus in which an electrochemical reaction takes place. In some embodiments, the electrochemical apparatus may include but is not limited to a lithium metal secondary battery, a lithium-ion secondary battery, a sodium-ion secondary battery, a lithium polymer secondary battery, or a lithium-ion polymer secondary battery.

The manufacturing method of the electrochemical apparatus is not particularly limited in this application, and any manufacturing method known in the art may be used, provided that the objectives of this application can be achieved.

A second aspect of this application provides an electronic apparatus including the electrochemical apparatus according to the first aspect of this application. Therefore, the beneficial effects of the electrochemical apparatus provided in the first aspect can be obtained.

The electronic apparatus of this application is not particularly limited and may be any known electronic apparatus in the prior art. In some embodiments, the electronic apparatus may include but is not limited to a notebook computer, a pen-input computer, a mobile computer, an electronic book player, a portable telephone, a portable fax machine, a portable copier, a portable printer, a stereo headset, a video recorder, a liquid crystal display television, a portable cleaner, a portable CD player, a mini-disc player, a transceiver, an electronic notebook, a calculator, a storage card, a portable recorder, a radio, a backup power source, a motor, an automobile, a motorcycle, a motor bicycle, a bicycle, a lighting appliance, a toy, a game machine, a clock, an electric tool, a flash lamp, a camera, a large household battery, a lithium-ion capacitor, and the like.

### EXAMPLES

The following describes the embodiments of this application more specifically by using examples and comparative examples. Various tests and evaluations are performed in the following methods. In addition, unless otherwise specified, “part” and “%” are based on weight.

Test Method and Device

Compacted Density Test:

The negative electrode plate already subjected to coating was placed on a cold press, and the roller gap size and preset pressure were adjusted for cold pressing. The thickness H of the cold-pressed negative electrode plate was measured, a unit area S of the negative electrode plate was cut by stamping, and the weight M1 was measured, from which the weight of the negative electrode current collector per M2 per unit area is subtracted. Then, the compacted density of the negative electrode plate was calculated according to (M1−M2)/(S×H).

Sphericity Test:

Image capture and processing were performed on a specific quantity (greater than 5000) of dispersed particles (particles of the first active substance and particles of the second active substance) with a Malvern automatic image particle size analyzer, then the microstructure and morphology of the particles were accurately analyzed by utilizing the morphologically directed Raman spectroscopy (MDRS) technology to obtain the longest diameters and the shortest diameters of all particles. A ratio of the shortest diameter to the longest diameter of each particle was calculated to obtain a sphericity of the particle, and an average sphericity was obtained by averaging all sphericities of all the particles. In this application, the sphericity of the first active substance refers to the average sphericity of the first active substance, and the sphericity of the second active substance refers to the average sphericity of the second active substance.

Raman Test:

The first active substance or the second active substance was placed on a glass plate and scanned using a Raman test device (surface scanning, with 100 points taken). The device could output the corresponding Raman spectra, and the value of Id₁/Ig₁ or Id₂/Ig₂ could be obtained from the spectra.

Test on Median Particle Size D50 of Polymer Particles:

In accordance with the national standard GB/T 19077-2016 (particle size distribution laser diffraction method), D50 was determined using a laser particle size analyzer (for example, Malvern Master Size 3000).

Swelling Degree Test:

Polymer particles were added to water to obtain an emulsion with a solid content of 30 wt %. The emulsion was applied on a glass substrate and dried at 85° C. to obtain a polymer particle film. The polymer particle film with a mass of m1 was soaked in the test electrolyte at 85° C. for 6 h, and the mass of the polymer particle film at this time was recorded as m2. The swelling degree of the polymer particles was calculated according to (m2−m1)/m1×100%. In each example or comparative example, the test was performed for three times, and an average value was used as a final swelling degree of the polymer particles.

The test electrolyte was composed of an organic solvent and lithium hexafluorophosphate. The organic solvent was obtained by mixing ethylene carbonate (EC), propylene carbonate (PC), and dimethyl carbonate (DMC) in a mass ratio of 70:20:10. The concentration of lithium hexafluorophosphate was 1 mol/L.

Adhesion Force Test:

The lithium-ion battery was fully charged and disassembled to obtain a laminated portion of separator and negative electrode plate. The laminated portion was cut into a 15 mm×54.2 mm strip sample, and the adhesion force between the separator and the negative electrode plate was tested according to the national standard GB/T 2792-1998 (Test method for peel strength of pressure-sensitive tape at 180° angle).

Rate Performance Test:

At a constant temperature of 25° C., the lithium-ion battery was charged to 4.45 V at a constant current of xxC (xx=3+0.2×n, where n=1, 2, 3, 4, . . . , and the value of n started from 1 and sequentially increased for each example or comparative example; when lithium precipitation occurred in the negative electrode plate, the rate was 3+0.2×(n+1), in which the n value was the maximum n value for the corresponding example or comparative example). Then, the battery was charged to 0.05 C at a constant voltage of 4.45 V, left standing for 5 min, discharged to 3 V at a constant current of 0.5 C, and then left standing for 5 min. This process was repeated for 10 cycles of charge and discharge test. Rate window: a maximum charge rate value for which no lithium precipitation occurs at the interface of the negative electrode plate after disassembly.

Using the rate window of Comparative Example 1 as a benchmark, rate window enhancement=rate window of each example or comparative example other than Comparative Example 1−rate window of Comparative Example 1.

The rate performance is characterized by the rate window enhancement.

Energy Density Test:

First, the lithium-ion battery of Comparative Example 1 was charged according to the following procedure and then discharged to obtain the discharge capacity of the lithium-ion battery: charged to 4.45 V at a constant current of 3 C, then charged to 0.05 C at a constant voltage of 4.45 V, and left standing for 5 min; and discharged to 3.0 V at a constant current of 0.5 C and left standing for 5 min to obtain the discharge capacity C1.

After the charging steps of the lithium-ion battery of Comparative Example 1 were complete, the length L, width W, and height H of the lithium-ion battery were measured using a laser thickness gauge to obtain the volume V of the lithium-ion battery of Comparative Example 1 according to L×W×H. The volumetric energy density (ED1) could be calculated using the following formula: ED1 (Wh/L)=C1/V.

The energy density ED of each example or comparative example other than Comparative Example 1 was obtained using the same steps.

Energy density increase (%)=(ED−ED1)/ED1×100%.

Cycling Performance Test:

At 25° C., the lithium-ion battery was charged to 4.45 V at a constant current of 0.7 C, charged to 0.05 C at a constant voltage of 4.45 V, and left standing for 5 min; discharged to 3.0 V at a constant current of 0.5 C, and left standing for 5 min; and a discharge capacity of the first cycle was recorded. Then, 800 cycles of charge and discharge test were performed in the same steps and a discharge capacity of the lithium-ion battery at the 800^{th} cycle was recorded.

Capacity retention rate (%) of the lithium-ion battery=(Discharge capacity at the 800^{th} cycle/Discharge capacity at the first cycle)×100%.

In each example or comparative example, four samples were tested, and an average value was obtained.

High-Temperature Stability Test:

The thickness TO of the lithium-ion battery at an initial voltage of 3.0 V was measured. The lithium-ion battery was fully charged according to the following steps: charged to 4.45 V at a constant current of 0.7 C, and then charged to 0.02 C at a constant voltage of 4.45 V. The thickness of the lithium-ion battery in the fully charged state was measured. The lithium-ion battery was stored at 80° C. for 8 h, and the thickness T1 of the lithium-ion battery after storage was measured.

Swelling rate (%)=(T1−T0)/T0×100%. The high-temperature stability of the lithium-ion battery was characterized by the swelling rate.

### Example 1-1

<Preparation of Separator>

A porous polyethylene substrate with a thickness of 7 μm was selected as the porous substrate layer.

Polymer particles polyvinylidene fluoride (with a weight-average molecular weight of 1 million), auxiliary binder polyacrylic acid (with a weight-average molecular weight of 400,000), dispersant benzyl ether, and deionized water were mixed in a mass ratio of 5:0.5:0.5:94 to obtain a first coating layer slurry. The median particle size D50 of the polymer particles was 0.8 μm.

Alumina, butadiene-styrene polymer (with a weight-average molecular weight of 120,000), and deionized water were mixed in a mass ratio of 35:10:55 to obtain a second coating layer slurry.

The second coating layer slurry and the first coating layer slurry were sequentially applied on two surfaces of the porous substrate layer in its thickness direction to form a separator with the first coating layer and second coating layer on both sides. The thickness of the first coating layer was 1 μm, the thickness of the second coating layer was 2 μm, the ratio of the area of the second coating layer to the area of the porous substrate layer was 1, and the ratio of the area of the first coating layer to the area of the porous substrate layer was 0.5 (recorded as A1).

<Preparation of Negative Electrode Plate>

A first negative electrode active substance graphite 1, a conductive agent conductive carbon black (Super P), a stabilizer carboxymethyl cellulose (CMC), and a binder styrene-butadiene rubber (SBR, with a weight-average molecular weight of 1 million) were mixed in a mass ratio of 96.7:1:0.6:1.7, and deionized water was added as a solvent to prepare a slurry with a solid content of 46 wt %. The slurry was stirred under an action of a vacuum mixer to obtain a uniform first negative electrode slurry. A second negative electrode active substance graphite 2, a conductive agent Super P, a stabilizer CMC, and a binder SBR were mixed at a mass ratio of 96.7:1:0.6:1.7, and deionized water was added as a solvent to prepare a slurry with a solid content of 46 wt %. The slurry was stirred under an action of a vacuum mixer to obtain a uniform second negative electrode slurry.

The first negative electrode slurry was evenly applied onto one surface of the negative electrode current collector copper foil with a thickness of 8 μm and dried at 90° C. to obtain a negative electrode plate coated with a first active material layer on one surface. Then, the second negative electrode slurry was evenly applied on the first active material layer with a thickness of 40 μm, to obtain the negative electrode plate coated with the first active material layer and second active material layer on one surface. Then, the foregoing steps were repeated on another surface of the negative electrode current collector copper foil to obtain the negative electrode plate coated with the first active material layer and second active material layer on both surfaces. The negative electrode plate was dried at 90° C. and then cold pressed, followed by cutting and tab welding, to obtain negative electrode plates of 72 mm×851 mm for later use. Based on total mass of the first active material layer and the second active material layer, a mass percentage of the first active material layer (recorded as W1) was 90%.

<Preparation of Positive Electrode Plate>

A positive electrode active substance LiCoO₂, a conductive agent conductive carbon black, and a binder polyvinylidene fluoride (PVDF, with a weight-average molecular weight of 1 million) were mixed at a mass ratio of 97.5:1.0:1.5, and N-methylpyrrolidone (NMP) was added to prepare a slurry with a solid content of 75 wt %. The slurry was stirred under an action of a vacuum mixer to obtain a uniform positive electrode slurry. The positive electrode slurry was uniformly applied on one surface of a positive electrode current collector aluminum foil and dried at 130° C. to obtain a positive electrode plate coated with a positive electrode active material layer on one surface. Then the foregoing steps were repeated on another surface of the positive electrode current collector aluminum foil to obtain the positive electrode plate coated with the positive electrode active material layer on both surfaces. The positive electrode plate was dried at 90° C. and then cold pressed, followed by cutting and tab welding, to obtain positive electrode plates of 74 mm×867 mm for later use.

<Preparation of Electrolyte>

In an environment with a water content of less than 10 ppm, non-aqueous organic solvents ethylene carbonate (EC), diethyl carbonate (DEC), PC, propyl propionate (PP), and vinylene carbonate (VC) were mixed in a mass ratio of 10:15:10:14:1, and then lithium hexafluorophosphate (LiPF₆) was added to the non-aqueous organic solvents, dissolved and mixed well to obtain an electrolyte. A concentration of LiPF₆ was 1 mol/L.

<Preparation of Lithium-Ion Battery>

The positive electrode plate, separator, and negative electrode plate prepared above were sequentially stacked so that the separator was located between the positive electrode plate and the negative electrode plate to provide separation. Then the resulting stack was wound to obtain an electrode assembly. The electrode assembly was placed into an aluminum-plastic film packaging bag and dewatered at 80° C. Then the electrolyte was injected, and processes such as vacuum packaging, standing, formation, and shaping were performed to obtain a lithium-ion battery.

### Examples 1-2 to 1-9

These examples were the same as Example 1-1, except that W1 was adjusted according to the preparation parameters in Table 1, the mass percentage of the second active material layer was changed accordingly, and the total mass of the first active material layer and second active material layer remained unchanged.

### Examples 1-10 to 1-13

These examples were the same as Example 1-2 except that the preparation parameters were adjusted according to Table 1.

### Example 1-14

This example was the same as Example 1-2, except that in <Preparation of separator>, the mass ratio of the polymer particles polyvinylidene fluoride, the auxiliary binder polyacrylic acid, the dispersant phenylether, and the deionized water was adjusted to 3:0.5:0.5:96 to make the adhesion force between the separator and the negative electrode plate as shown in Table 1.

### Example 1-15

This example was the same as Example 1-2, except that in <Preparation of separator>, the mass ratio of the polymer particles polyvinylidene fluoride, the auxiliary binder polyacrylic acid, the dispersant phenylether, and the deionized water was adjusted to 3.5:0.5:0.5:95.5 to make the adhesion force between the separator and the negative electrode plate as shown in Table 1.

### Examples 2-1 to 2-4

These examples were the same as Example 1-2 except that the preparation parameters were adjusted according to Table 2.

### Examples 3-1 to 3-13

These examples were the same as Example 1-2 except that the preparation parameters were adjusted according to Table 3.

### Example 3-14

This example was the same as Example 1-2 except that in <Preparation of separator>, no second coating layer was provided.

### Comparative Example 1

This comparative example was the same as Example 1-2, except that in <Preparation of negative electrode plate>, no second active material layer was provided, and that in <Preparation of separator>, the mass ratio of the polymer particles polyvinylidene fluoride, the auxiliary binder polyacrylic acid, the dispersant phenylether, and the deionized water was adjusted to 5:0.5:0.5:94 and the median particle size D50 of the polymer particles was adjusted to 7 μm for making the adhesion force between the separator and the negative electrode plate as shown in Table 1.

### Comparative Example 2

This comparative example was the same as Example 1-2, except that in <Preparation of separator>, the mass ratio of the polymer particles polyvinylidene fluoride, the auxiliary binder polyacrylic acid, the dispersant phenylether, and the deionized water was adjusted to 5:0.5:0.5:94 and the median particle size D50 of the polymer particles was adjusted to 7 μm to make the adhesion force between the separator and the negative electrode plate as shown in Table 1.

### Comparative Example 3

This comparative example was the same as Example 1-2 except that in <Preparation of negative electrode plate>, no second active material layer was provided.

### Comparative Example 4

This comparative example was the same as Example 1-2 except that in <Preparation of negative electrode plate>, no first active material layer was provided.

Preparation parameters and performance parameters of the examples and comparative examples are shown in Table 1 to Table 3.

TABLE 1

| | | | | | | | | Energy | | | |
|---|---|---|---|---|---|---|---|---|---|---|---|
| | | | | | | | Adhesion | density | Rate | Capacity | Swelling |
| | D1 (g/ | D2 (g/ | | | W1 | | force | increase | window | retention | rate |
| | cm³) | cm³) | S1 | S2 | (%) | A1 | (N/m) | (%) | enhancement | rate (%) | (%) |
| Example 1-1 | 1.8 | 1.6 | 0.75 | 0.85 | 90 | 0.50 | 12 | 1.8 | 0.2C | 56.4 | 6.6 |
| Example 1-2 | 1.8 | 1.6 | 0.75 | 0.85 | 80 | 0.50 | 12 | 1.6 | 0.6C | 83.1 | 6.5 |
| Example 1-3 | 1.8 | 1.6 | 0.75 | 0.85 | 70 | 0.50 | 12 | 1.4 | 0.6C | 83.5 | 6.3 |
| Example 1-4 | 1.8 | 1.6 | 0.75 | 0.85 | 60 | 0.50 | 12 | 1.2 | 0.6C | 84.2 | 6.7 |
| Example 1-5 | 1.8 | 1.6 | 0.75 | 0.85 | 50 | 0.50 | 12 | 1.0 | 0.6C | 83.6 | 7.1 |
| Example 1-6 | 1.8 | 1.6 | 0.75 | 0.85 | 40 | 0.50 | 12 | 0.8 | 0.6C | 85.1 | 7.3 |
| Example 1-7 | 1.8 | 1.6 | 0.75 | 0.85 | 30 | 0.50 | 12 | 0.6 | 0.6C | 84.6 | 7.6 |
| Example 1-8 | 1.8 | 1.6 | 0.75 | 0.85 | 20 | 0.50 | 12 | 0.4 | 0.6C | 84.2 | 8.0 |
| Example 1-9 | 1.8 | 1.6 | 0.75 | 0.85 | 10 | 0.50 | 12 | 0.2 | 0.6C | 83.8 | 8.8 |
| Example 1-10 | 1.9 | 1.7 | 0.75 | 0.85 | 80 | 0.50 | 12 | 2.0 | 0.05C | 83.2 | 6.8 |
| Example 1-11 | 1.7 | 1.5 | 0.75 | 0.85 | 80 | 0.50 | 12 | 1.4 | 0.65C | 83.1 | 6.5 |
| Example 1-12 | 1.8 | 1.6 | 0.8 | 0.9 | 80 | 0.50 | 12 | 1.55 | 0.65C | 83.4 | 6.8 |
| Example 1-13 | 1.8 | 1.6 | 0.7 | 0.8 | 80 | 0.50 | 12 | 1.65 | 0.55C | 83.2 | 6.4 |
| Example 1-14 | 1.8 | 1.6 | 0.75 | 0.85 | 80 | 0.50 | 2 | 1.2 | 0.6C | 83.4 | 9.8 |
| Example 1-15 | 1.8 | 1.6 | 0.75 | 0.85 | 80 | 0.50 | 6 | 1.4 | 0.6C | 83.3 | 8.6 |
| Comparative | 1.8 | \ | 0.75 | \ | 100 | 0.50 | 1 | 0 | 0 | 83.2 | 13.4 |
| Example 1 | | | | | | | | | | | |
| Comparative | 1.8 | 1.6 | 0.75 | 0.85 | 80 | 0.50 | 1 | −0.4 | 0.6C | 84.3 | 13.8 |
| Example 2 | | | | | | | | | | | |
| Comparative | 1.8 | \ | 0.75 | \ | 100 | 0.50 | 12 | 2 | 0 | 45.3 | 6.3 |
| Example 3 | | | | | | | | | | | |
| Comparative | \ | 1.6 | \ | 0.75 | 0 | 0.50 | 12 | −1.0 | 0.6C | 81.2 | 6.9 |
| Example 4 | | | | | | | | | | | |

Note:
“\” in Table 1 means that a corresponding preparation parameter does not exist.

From Table 1, it can be seen that in Examples 1-1 to 1-15, when a separator with an adhesion force between the separator and the negative electrode plate greater than or equal to 2 N/m and less than or equal to 20 N/m is used, the compacted density D1 of the first active material layer in the negative electrode plate is greater than the compacted density D2 of the second active material layer, and the sphericity S1 of the first active substance is less than the sphericity S2 of the second active substance, the lithium-ion batteries exhibit improved energy density and rate performance, as well as high capacity retention and low swelling rate. This indicates that the lithium-ion batteries have good cycling performance and high-temperature stability, and the overall performance of the lithium-ion batteries is improved.

However, in Comparative Examples 1 to 4, when a non-highly-adhesive separator with an adhesion force between the separator and the negative electrode plate less than 2 N/m, and/or the negative electrode plate does not have the first active material layer and second active material layer at the same time, at least one selected from the group consisting of the energy density, rate performance, cycling performance, and high-temperature stability of the lithium-ion batteries is not improved. This indicates that the overall performance of the lithium-ion batteries is not improved.

Based on total mass of the first active material layer and the second active material layer, the mass percentage W1 of the first active material layer usually affects the overall performance of the lithium-ion batteries. It can be learned from Examples 1-1 to 1-9 and Comparative Examples 3 and 4 that when the mass percentage W1 of the first active material layer is within the range defined in this application, the lithium-ion batteries have good overall performance.

The compacted density D1 of the first active material layer and the compacted density D2 of the second active material layer usually affect the overall performance of the lithium-ion batteries. It can be learned from Examples 1-2, 1-10, and 1-11 that when the compacted density D1 of the first active material layer and the compacted density D2 of the second active material layer are within the ranges defined in this application, the lithium-ion batteries have good overall performance.

The sphericity S1 of the first active substance and the sphericity S2 of the second active substance usually affect the overall performance of the lithium-ion batteries. It can be learned from Examples 1-2, 1-12, and 1-13 that when the sphericity S1 of the first active substance and the sphericity S2 of the second active substance are within the ranges defined in this application, the lithium-ion batteries have good overall performance.

The adhesion force between the separator and the negative electrode plate usually affects the overall performance of the lithium-ion batteries. It can be learned from Examples 1-2, 1-14, and 1-15 and Comparative Example 2 that when the adhesion force between the separator and the negative electrode plate is within the range defined in this application, the lithium-ion batteries have good overall performance.

TABLE 2

| | | | | | Energy | | | |
|---|---|---|---|---|---|---|---|---|
| | First | Second | | | density | Rate | Capacity | Swelling |
| | active | active | | | increase | window | retention | rate |
| | substance | substance | Id₁/Ig₁ | Id₂/Ig₂ | (%) | enhancement | rate (%) | (%) |
| Example 1-2 | Graphite 1 | Graphite 2 | 0.19 | 0.5 | 1.6 | 0.6C | 83.1 | 6.5 |
| Example 2-1 | Silicon | Graphite 2 | / | 0.5 | 2.4 | 0.6C | 80.1 | 7.9 |
| | carbide | | | | | | | |
| Example 2-2 | Tin oxide | Graphite 2 | / | 0.5 | 2.2 | 0.6C | 80.6 | 7.7 |
| Example 2-3 | Graphite 3 | Graphite 4 | 0.15 | 0.18 | 1.4 | 0.2C | 80.2 | 6.8 |
| Example 2-4 | Graphite 5 | Graphite 6 | 0.06 | 0.4 | 1.7 | 0.5C | 81.4 | 6.2 |

The types of the first active substance and second active substance usually affect the overall performance of the lithium-ion batteries. It can be learned from Examples 1-2, 2-1, and 2-4 that when the types of the first active substance and the second active substance are within the ranges defined in this application, the lithium-ion batteries have good overall performance.

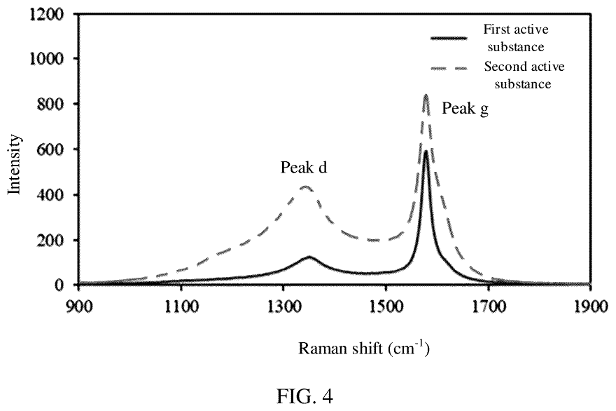

FIG. 4 shows Raman spectra of the first active substance and the second active substance of Example 1-2. As shown in FIG. 4, the peak intensity ratio Id₁/Ig₁ of peak d and peak g in the Raman test of the first active substance is 0.19, and the peak intensity ratio Id₂/Ig₂ of peak d and peak g in the Raman test of the second active substance is 0.5.

It can be learned from Examples 1-2, 2-3, and 2-4 that when both the first active substance and the second active substance are carbon-based materials, 0<Id₁/Ig₁<0.2, and 0.2<Id₂/Ig₂≤1, the lithium-ion batteries exhibit good rate performance, energy density, and cycling performance while maintaining a low swelling rate, or a good high-temperature stability. This indicates that the lithium-ion batteries have good overall performance.

TABLE 3

| | | | | | Energy | | | |
|---|---|---|---|---|---|---|---|---|
| | | | | Swelling | density | | Capacity | Swelling |
| | | | D50 | degree | increase | Rate window | retention | rate |
| | A1 (%) | Polymer particle | (μm) | (%) | (%) | enhancement | rate (%) | (%) |
| Example 1-2 | 0.50 | Polyvinylidene fluoride | 0.8 | 40 | 1.6 | 0.6C | 83.1 | 6.5 |
| Example 3-1 | 0.10 | Polyvinylidene fluoride | 0.8 | 40 | 1.4 | 0.6C | 84.2 | 8.2 |
| Example 3-2 | 0.30 | Polyvinylidene fluoride | 0.8 | 40 | 1.5 | 0.6C | 83.4 | 6.8 |
| Example 3-3 | 0.40 | Polyvinylidene fluoride | 0.8 | 40 | 1.55 | 0.6C | 83.3 | 6.7 |
| Example 3-4 | 0.70 | Polyvinylidene fluoride | 0.8 | 40 | 1.65 | 0.6C | 82.6 | 6.2 |
| Example 3-5 | 0.85 | Polyvinylidene fluoride | 0.8 | 40 | 1.7 | 0.6C | 81.9 | 6.3 |
| Example 3-6 | 0.50 | Polyvinylidene chloride | 0.8 | 40 | 1.6 | 0.6C | 82.7 | 6.4 |
| Example 3-7 | 0.50 | Polyhexafluoropropylene | 0.8 | 40 | 1.6 | 0.6C | 83.3 | 7.1 |
| | | (weight-average molecular | | | | | | |
| | | weight: 550,000) | | | | | | |
| Example 3-8 | 0.50 | Polystyrene | 0.8 | 40 | 1.6 | 0.6C | 82.9 | 6.8 |
| | | (weight-average molecular | | | | | | |
| | | weight: 300,000) | | | | | | |
| Example 3-9 | 0.50 | Polyvinylidene fluoride | 0.2 | 40 | 1.65 | 0.6C | 80.5 | 6.1 |
| Example 3-10 | 0.50 | Polyvinylidene fluoride | 0.3 | 40 | 1.64 | 0.6C | 81.2 | 6.3 |
| Example 3-11 | 0.50 | Polyvinylidene fluoride | 0.6 | 40 | 1.62 | 0.6C | 82.5 | 6.4 |
| Example 3-12 | 0.50 | Polyvinylidene fluoride | 1 | 40 | 1.57 | 0.6C | 83.3 | 6.6 |
| Example 3-13 | 0.50 | Polyvinylidene fluoride | 2 | 40 | 1.4 | 0.6C | 84.5 | 7.2 |
| Example 3-14 | 0.50 | Polyvinylidene fluoride | 0.8 | 40 | 2.63 | 0.6C | 52.8 | 16.4 |

Note:
In Example 3-14, no second coating layer is provided.

The ratio A1 of the area of the first coating layer to the area of the porous substrate layer usually affects the overall performance of the lithium-ion batteries. It can be learned from Examples 1-2, 3-1 to 3-5 that when the ratio A1 of the area of the first coating layer to the area of the porous substrate layer is within the range defined in this application, the lithium-ion batteries have good overall performance.

The type of the polymer particles in the first coating layer usually affects the overall performance of the lithium-ion batteries. It can be learned from Examples 1-2, 3-6 to 3-8 that when the type of the polymer particles in the first coating layer is within the range defined in this application, the lithium-ion batteries have good overall performance.

The median particle size D50 of the polymer particles in the first coating layer usually affects the overall performance of the lithium-ion batteries. It can be learned from Examples 1-2, 3-9 to 3-13 that when the median particle size D50 of the polymer particles in the first coating layer is within the range defined in this application, the lithium-ion batteries have good overall performance.

In Example 3-14, no second coating layer is provided, and the thickness of the separator is reduced, resulting in further improvement in the energy density of the lithium-ion battery. However, due to the lack of protection from the second coating layer, the lithium-ion battery is prone to self-discharge, and the cycling performance deteriorates quickly. The side reactions between the positive and negative electrodes during cycling are intensified, resulting in decreased cycling performance compared to Example 1-2. Additionally, compared to Example 1-2, Example 3-14 exhibits increased swelling rate, indicating a decrease in high-temperature stability of the lithium-ion battery.

It should be noted that relational terms such as “first” and “second” are only used to distinguish one entity or operation from another entity or operation, and do not necessarily require or imply that there is any such actual relationship or order between these entities or operations. In addition, the terms “include”, “comprise”, or any of their variants are intended to cover a non-exclusive inclusion, such that a process, method, article, or device that includes a series of elements includes not only those elements but also other elements that are not expressly listed, or further includes elements inherent to such process, method, article, or device.

The embodiments in this specification are described in a related manner. For a part that is the same or similar between different embodiments, reference may be made between the embodiments. Each embodiment focuses on differences from other embodiments.

The foregoing descriptions are merely preferred examples of this application, and are not intended to limit the protection scope of this application. Any modifications, equivalent replacements, and improvements made without departing from the spirit and principle of this application shall fall within the protection scope of this application.

What is claimed is:

1. An electrochemical apparatus, comprising an electrode assembly; wherein the electrode assembly comprises a positive electrode plate, a negative electrode plate, and a separator disposed between the positive electrode plate and the negative electrode plate;
the negative electrode plate comprises a negative electrode current collector, a first active material layer and a second active material layer; the first active material layer and the second active material layer being disposed on at least one surface of the negative electrode current collector, wherein the first active material layer being located between the negative electrode current collector and the second active material layer;
the first active material layer comprises a first active substance, and the second active material layer comprises a second active substance, wherein a compacted density of the first active material layer is greater than a compacted density of the second active material layer, and a sphericity of the first active substance is smaller than a sphericity of the second active substance; and
the separator comprises a porous substrate layer and a first coating layer, wherein the first coating layer is disposed on at least one surface of the porous substrate layer facing the second active material layer, and an adhesion between the separator and the negative electrode plate is greater than or equal to 2 N/m and less than or equal to 20 N/m.

2. The electrochemical apparatus according to claim 1, wherein based on a total mass of the first active material layer and the second active material layer, a mass percentage of the first active material layer is 10% to 90%.

3. The electrochemical apparatus according to claim 2, wherein based on the total mass of the first active material layer and the second active material layer, the mass percentage of the first active material layer is 20% to 80%.

4. The electrochemical apparatus according to claim 1, wherein the compacted density of the first active material layer is D1, wherein 1.7 g/cm³<D1≤1.9 g/cm³; the compacted density of the second active material layer is D2, wherein 1.5 g/cm³≤D2≤1.7 g/cm³;
the sphericity of the first active substance is S1, wherein 0.7≤S1≤0.8; and the sphericity of the second active substance is S2, wherein 0.8<S2≤0.9.

5. The electrochemical apparatus according to claim 1, wherein the first active substance and the second active substance each independently are at least one selected from the group consisting of a carbon-based material, a silicon-based material, and a tin-based material; wherein the carbon-based material comprises at least one selected from the group consisting of natural graphite, artificial graphite, soft carbon, hard carbon, and mesocarbon microbeads.

6. The electrochemical apparatus according to claim 5, wherein both the first active substance and the second active substance are carbon-based materials; the first active substance has a peak intensity ratio of peak d to peak g in the Raman test is Id₁/Ig₁, wherein 0<Id₁/Ig₁<0.2; and the second active substance has a peak intensity ratio of peak d to peak g in the Raman test is Id₂/Ig₂, wherein 0.2<Id₂/Ig₂≤1; wherein peak d has a wavelength range of 1270 cm⁻¹ to 1330 cm⁻¹ in the Raman spectrum, and peak G has a wavelength range of 1550 cm⁻¹ to 1610 cm⁻¹ in the Raman spectrum.

7. The electrochemical apparatus according to claim 1, wherein a second coating layer is further disposed between the porous substrate layer and the first coating layer, wherein the second coating layer comprises heat-resistant particles, and the heat-resistant particles comprise at least one selected from the group consisting of alumina, boehmite, barium sulfate, titanium dioxide, and magnesium hydroxide.

8. The electrochemical apparatus according to claim 1, wherein a ratio of an area of the first coating layer to an area of the porous substrate layer is 0.10 to 0.85.

9. The electrochemical apparatus according to claim 1, wherein the first coating layer comprises polymer particles, wherein the polymer particles comprise polymers polymerized from at least one selected from the group consisting of the following monomers: vinylidene chloride, vinylidene fluoride, hexafluoropropylene, styrene, butadiene, acrylonitrile, acrylic acid, methyl acrylate, and butyl acrylate.

10. The electrochemical apparatus according to claim 9, wherein a median particle size D50 of the polymer particles is 0.2 μm to 2 μm.

11. The electrochemical apparatus according to claim 9, wherein a swelling degree of the polymer particles is 20% to 100%.

12. The electrochemical apparatus according to claim 9, wherein the polymer particles are core-shell structured microspheres, and each polymer particle comprises a shell and a core, wherein
the shell comprises polymers polymerized from at least one selected from the group consisting of the following monomers: polyvinyl chloride, polyvinyl fluoride, hexafluoropropylene, polystyrene, polybutadiene, acrylonitrile, acrylic acid, methyl acrylate, and butyl acrylate; and
the core comprises at least one selected from the group consisting of acrylate and acrylate polymer.

13. The electrochemical apparatus according to claim 12, wherein the electrochemical apparatus satisfies at least one selected from the group consisting of the following characteristics:
(a) a ratio of an area of the first coating layer to an area of the porous substrate layer is 0.30 to 0.70;
(b) a median particle size D50 of the polymer particles is 0.3 μm to 11 μm;
(c) the shell comprises at least one selected from the group consisting of polyvinylidene fluoride, polyvinylidene chloride, styrene-butadiene copolymer, acrylonitrile, butadiene-acrylonitrile copolymer, acrylic acid, styrene-methyl methacrylate copolymer, and styrene-butyl methacrylate copolymer; and
(d) the core comprises at least one selected from the group consisting of methyl acrylate and butyl acrylate.

14. The electrochemical apparatus according to claim 9, wherein the polymer particles comprise at least one selected from the group consisting of polyvinylidene fluoride, polyvinylidene chloride, styrene-butadiene copolymer, acrylonitrile, butadiene-acrylonitrile copolymer, acrylic acid, styrene-methyl methacrylate copolymer, and styrene-butyl methacrylate copolymer.

15. An electronic apparatus, comprising an electrochemical apparatus; wherein the electrochemical apparatus comprises an electrode assembly, wherein the electrode assembly comprises a positive electrode plate, a negative electrode plate, and a separator disposed between the positive electrode plate and the negative electrode plate;
the negative electrode plate comprises a negative electrode current collector, a first active material layer and a second active material layer; the first active material layer and the second active material layer being disposed on at least one surface of the negative electrode current collector, wherein the first active material layer being located between the negative electrode current collector and the second active material layer;
the first active material layer comprises a first active substance, and the second active material layer comprises a second active substance, wherein a compacted density of the first active material layer is greater than a compacted density of the second active material layer, and a sphericity of the first active substance is smaller than a sphericity of the second active substance; and
the separator comprises a porous substrate layer and a first coating layer, wherein the first coating layer is disposed on at least one surface of the porous substrate layer facing the second active material layer, and an adhesion between the separator and the negative electrode plate is greater than or equal to 2 N/m and less than or equal to 20 N/m.

16. The electronic apparatus according to claim 15, wherein based on a total mass of the first active material layer and the second active material layer, a mass percentage of the first active material layer is 10% to 90%.

17. The electronic apparatus according to claim 16, wherein based on the total mass of the first active material layer and the second active material layer, the mass percentage of the first active material layer is 20% to 80%.

18. The electronic apparatus according to claim 17, wherein the compacted density of the first active material layer is D1, wherein 1.7 g/cm3<D1≤1.9 g/cm3; the compacted density of the second active material layer is D2, wherein 1.5 g/cm3≤D2≤1.7 g/cm3;
the sphericity of the first active substance is S1, wherein 0.7≤S1≤0.8; and the sphericity of the second active substance is S2, wherein 0.8<S2≤0.9.

19. The electronic apparatus according to claim 18, wherein the first active substance and the second active substance each independently are at least one selected from the group consisting of a carbon-based material, a silicon-based material, and a tin-based material;
wherein the carbon-based material comprises at least one selected from the group consisting of natural graphite, artificial graphite, soft carbon, hard carbon, and mesocarbon microbeads.

20. The electronic apparatus according to claim 19, wherein both the first active substance and the second active substance are carbon-based materials; the first active substance has a peak intensity ratio of peak d to peak g in the Raman test is Id₁/Ig₁, wherein 0<Id₁/Ig₁<0.2; and the second active substance has a peak intensity ratio of peak d to peak g in the Raman test is Id₂/Ig₂, wherein 0.2<Id₂/Ig₂≤1; wherein peak d has a wavelength range of 1270 cm⁻¹ to 1330 cm⁻¹ in the Raman spectrum, and peak G has a wavelength range of 1550 cm⁻¹ to 1610 cm⁻¹ in the Raman spectrum.
